(19) United States
(12) Patent Application Publication
(10) Pub. No.: US 2014/0308101 A1
(43) Pub. Date: Oct. 16, 2014

(54) LIFT FOR A BICYCLE RACK OR LUGGAGE RACK

(71) Applicant: BROSTOR, naamloze vennootschap, Wevelgem (BE)

(72) Inventor: Lieven Louis Lucien BRUTSAERT, Menen (BE)

(73) Assignee: BROSTOR, naamloze vennootschap, Wevelgem (BE)

(21) Appl. No.: 14/249,787

(22) Filed: Apr. 10, 2014

(30) Foreign Application Priority Data
Apr. 11, 2013 (BE) 2013 /0265

(51) Int. Cl. B60R 9/06

(52) U.S. Cl. CPC B60R 9/06
USPC 414/462

(57) ABSTRACT

Lift for a bicycle rack or luggage rack, whereby this lift (1) includes a frame (3) for mounting against a wall; a guide (6) provided on this frame (3) which extends in an essentially upward direction; a height-adjustable carriage (7) on this guide (6) to which the bicycle rack or luggage rack (2) is fastened; and drive elements (24) for moving the carriage (7), whereby the guide (6) is extendable by including a ‘fixed part’ (8) that is fastened on the frame (3) and a ‘movable part’ (9) that can be moved vertically with respect to the fixed part (8) of the guide.

### FIELD OF THE INVENTION

The present invention relates to a lift for a bicycle rack or luggage rack.

More specifically the invention relates to a bicycle rack or luggage rack for mounting on a vehicle such as a motor home, caravan or similar, but is not limited to them.

### BACKGROUND OF THE INVENTION

Generally bicycle racks are mounted in a fixed position on the vehicle. To load and unload the bicycles, they must be lifted on and off the bicycle rack which can sometimes be difficult.

Bicycle tourism is currently well on the rise, especially among pensioners who often purchase an electric bicycle. However, such bicycles are relatively heavy, which makes the lifting for loading and unloading on a fixed bicycle rack particularly difficult, especially for older people who nowadays increasingly enjoy convenience, and above all when the bicycle rack is mounted reasonably high up in order to be out of the way.

Bicycle racks are also known that are mounted on a lift that is mounted against the back wall of a motor home or similar, and which enables the bicycle rack to descend to ground level for loading and unloading the bicycles, and to raise it again to a position away from the ground for driving.

Such a known lift consists of a frame for mounting against a wall; a guide provided on this frame that extends in an essentially upward direction in the mounted position of the lift; a vertically movable carriage on this guide to which the bicycle rack or luggage rack is fastened and drive means for the movement of the carriage.

A disadvantage of such a known bicycle rack is that the vertical travel of the bicycle rack is limited.

This means that the bicycle rack must be mounted quite low on the vehicle in order to enable the bicycle rack to descend to ground level.

This also implies that in the highest position of the lift, the bicycles are suspended quite low, which is not conducive to safety during driving, and increases the potential risk of theft.

Such a lift also sometimes forms an obstacle to access to the luggage or engine compartment, or presents an obstruction to the view through a window or an obstruction to the view of the number plate and indicator lighting, such that extra facilities are needed for auxiliary lights and an extra number plate that is then mounted on the bicycle rack.

Moreover, it is not always possible to mount such a bicycle rack in the most suitable place on account of the presence of a bumper, a window, a door, a spare wheel or similar.

### SUMMARY OF THE INVENTION

The purpose of the present invention is to provide a solution to the aforementioned and other disadvantages.

To this end to the invention concerns a lift for a bicycle rack or luggage rack of the aforementioned type whereby the guide on which the carriage can be moved is extendable by comprising a fixed part that is fastened to the frame and a movable part that can be moved vertically with respect to the fixed part of the guide between a position of minimum length and a position of maximum length, whereby the aforementioned carriage is affixed in a height-adjustable way between a top and a bottom position on the movable part of the guide.

In this way the range or the travel of the lift is increased substantially, such that the lift can be mounted higher than the known bicycle racks, or at least there is greater freedom in the choice of the height at which the bicycle rack can be mounted on the motor home, without this choice necessarily being limited by the presence of windows doors, bumpers, number plates and similar, and this while the bicycle rack can be lowered to the ground without problems.

This also provides the advantage that the bicycles or luggage can be raised to a transport or storage position, which is safer during driving and reduces the risk of theft.

Preferably the fixed part and the movable part of the guide are movable with respect to one another such that the length of the guide is extendable by at least 50%, preferably by at least 60%, and most preferably by at least 70% with respect to its minimum length.

According to a preferred characteristic the fixed part and the movable part of the guide are approximately the same length and both parts slide completely into one another so that the minimum length of the guide approximately corresponds to the length of both parts, which enables the lift to be slid together in a compact way.

Preferably the carriage is movable over the entire or practically the entire length of the movable part of the guide, which further increases the travel of the bicycle rack.

According to a preferred characteristic the lift is provided with a spring or gas spring between the fixed part of the guide and the carriage, such that the weight of the bicycle rack and the bicycles on it can be somewhat compensated, such that less force and power are required to move the lift up and down.

The drive of the carriage can be simply realised in the form of a cable that is wound on a shaft above the fixed part of the guide, and which is fastened to the carriage, whereby the shaft is rotatable in order to wind up or unwind the cable to lower the bicycle rack or luggage rack down to the ground or to lift it up to a transport or storage position.

Preferably the lift is provided with cable-break protection that automatically blocks the downward movement of the carriage if the aforementioned cable breaks in order to prevent the bicycle rack crashing down in the event of a cable break, with all the consequences for the bicycle rack, the bicycles, and the traffic behind if components thereby detach or break off.

According to another preferred characteristic the bicycle rack or luggage rack is height adjustable with respect to the carriage, which allows greater freedom for its mounting with regard to the mounting height of the lift.

An even greater freedom of choice of the mounting locations of the lift can be obtained when the frame for mounting the lift against the vehicle is adjustable in length.

### BRIEF DESCRIPTION OF THE DRAWINGS

With the intention of better showing the characteristics of the invention, a few preferred embodiments of a lift for a bicycle rack or luggage rack according to the invention are described hereinafter by way of an example, without any limiting nature, with reference to the accompanying drawings, wherein:

FIG. 1 schematically shows a perspective view of a lift with bicycle rack according to the invention;

FIG. 2 shows a cross-section according to line II-II in FIG. 1;

FIG. 3 shows a side view of the bicycle rack of FIG. 1 in a mounted situation on the back of a motor home;

FIGS. 4 to 7 show the lift of FIG. 2 in different positions and mounting possibilities;

FIG. 8 shows the section indicated in FIG. 2 by the box F8 on a larger scale;

FIG. 9 shows a section of FIG. 8 in a different position;

FIGS. 10 and 11 illustrate the movement of a lift according to the invention in another embodiment;

FIG. 12 shows a variant of a lift according to the invention;

FIG. 13 shows a cross-section according to line XIII-XIII in FIG. 12.

### DETAILED DESCRIPTION OF THE INVENTION

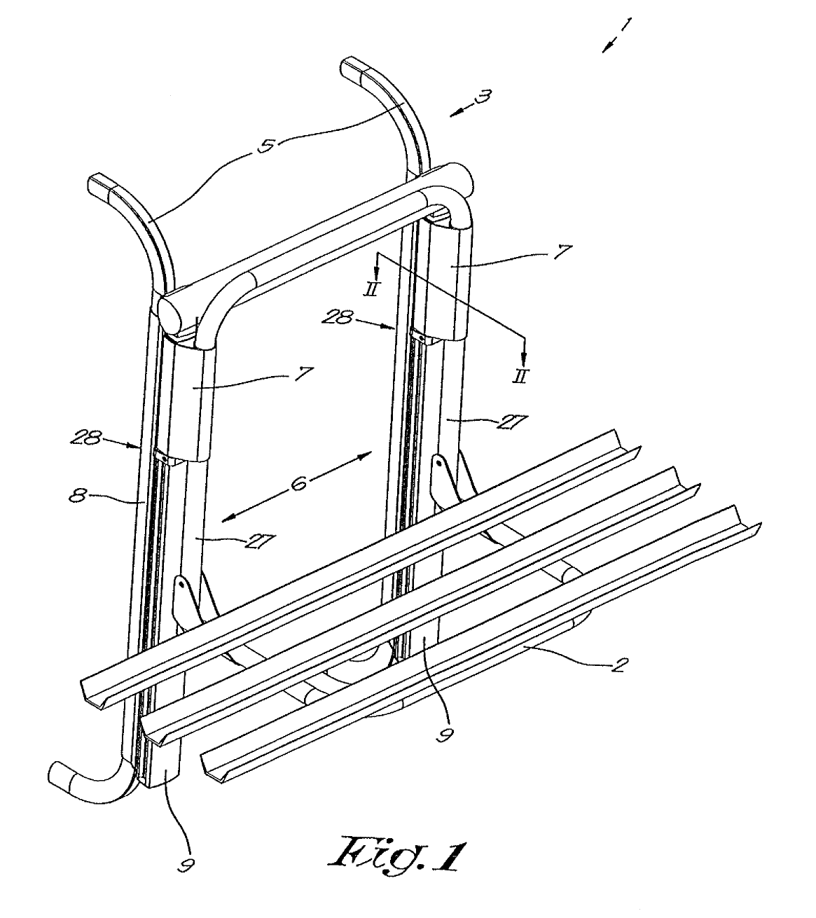

The lift 1 shown in FIG. 1 is provided with a bicycle rack 2 by way of an example, but alternatively can also be provided with a load platform or box for luggage.

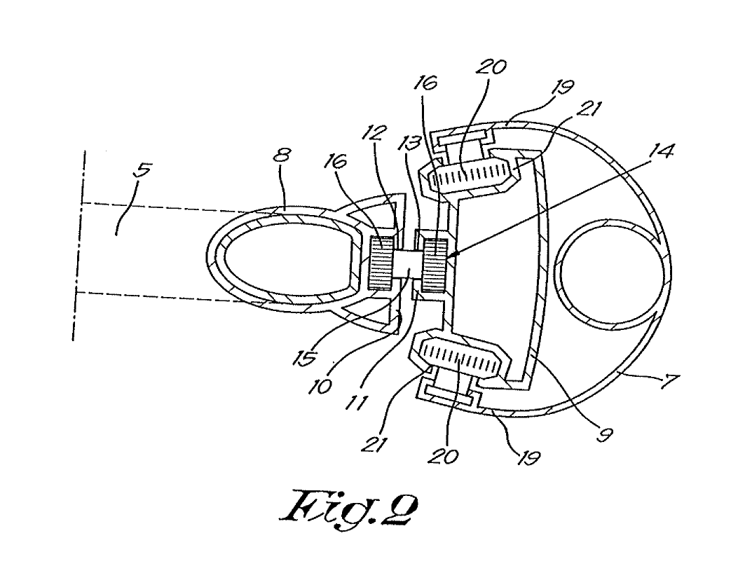

The lift 1 is provided with a frame 3 for mounting on a motor home 4 or similar, as shown in FIG. 2.

In this case, this frame 3 is formed by two brackets 5 with an essentially vertically oriented guide 6 on each bracket 5 for a carriage 7 that is height adjustable on the guide 6 and to which the bicycle rack 3 is fastened.

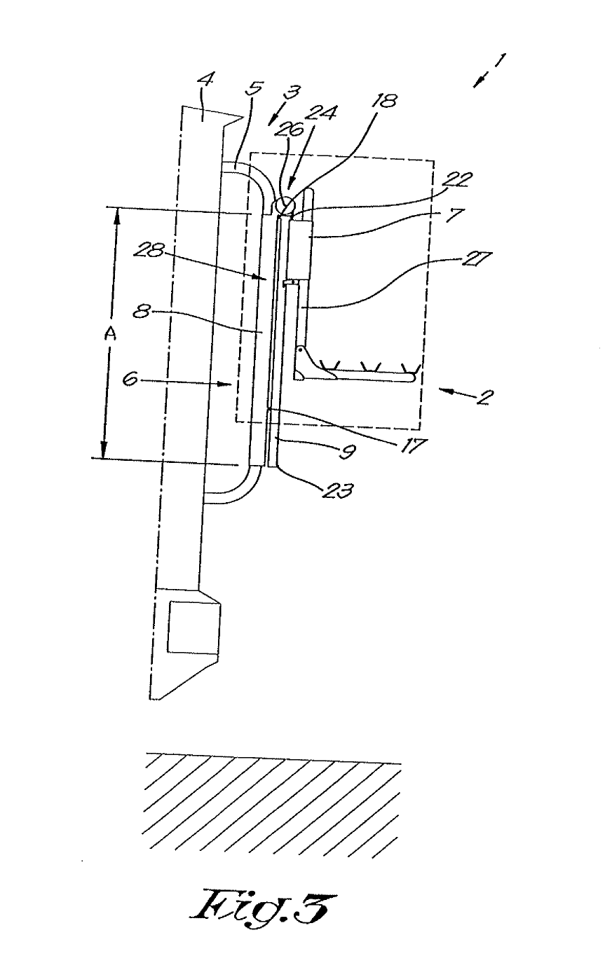

Each guide 6 is composed of two parallel parts of practically the same length, respectively a fixed part 8 that is fastened to the frame 3 and a movable part 9 that is movable in the longitudinal direction with respect to the fixed part 8 in order to make the guide longer or shorter between a situation of minimum length A in which both parts 8 and 9 are completely slid together, as shown in FIGS. 1 and 3, and a situation of maximum length B whereby the two parts 8 and 9 are slid out from one another to a maximum, as shown in FIG. 4.

In the example shown in FIGS. 1 and 2 both parts 8 and 9 are constructed as profiles that are provided with a groove and 13 respectively on the walls 10 and 11 oriented towards one another, and both parts 8 and 9 are connected together by means of one or more sliding parts 14 with an I-shaped cross-section, as shown in FIG. 2, whereby the body 15 of the sliding parts 14 extends with a good fit through the aforementioned grooves 12 and 13 and are held movably by their flanges 16 behind at least one of the aforementioned walls 10 or 11 of the profiles.

Preferably the maximum length B of the guide 6 is at least 50% larger than its minimum length A.

The maximum length B of the guide 6 is limited by an end stop 17 on the fixed part 8 that can engage with an end stop 18 on the movable part 9, so that both parts overlap one another by a distance C with a maximum length B.

The carriage 7 is affixed movably on the movable part 9 of the guide 6, whereby the carriage 7 is constructed with an essentially U-shaped cross-section with two arms 19 with which the carriage 7 is affixed over the movable part 9 and whereby the arms 19 are provided with wheels or sliding blocks 20 on the inside that are held in the grooves 21 with a close fit on the sides of the movable part 9 of the guide 6.

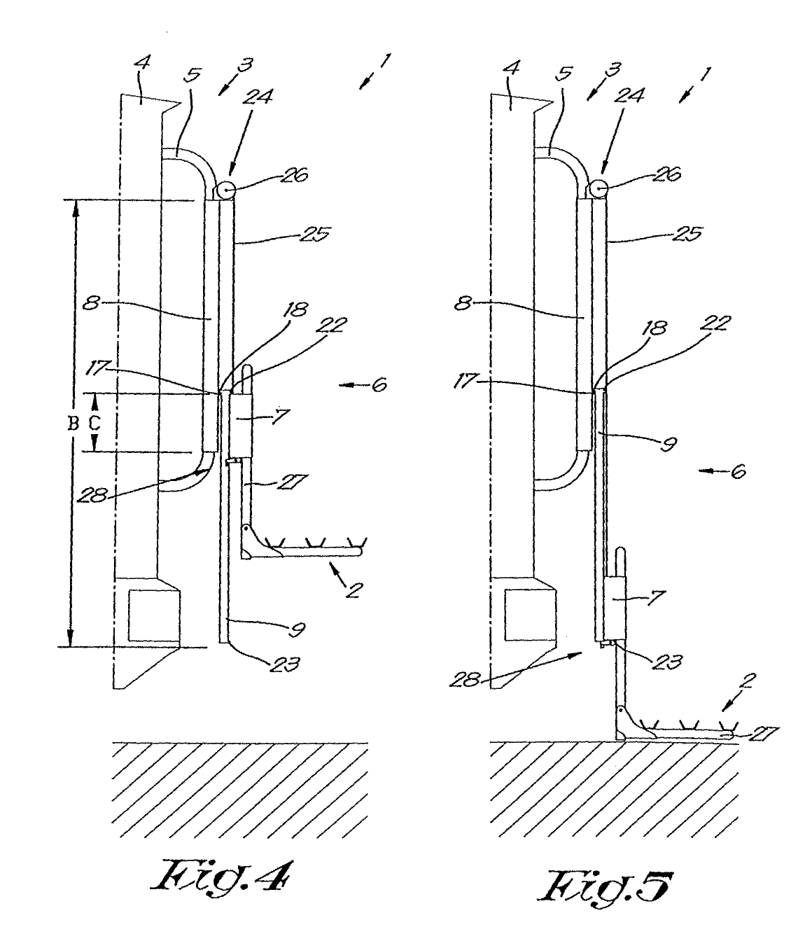

The carriage 7 is movable over the entire or practically entire length of the movable part 9 between a top position, as shown in FIG. 3, and a bottom position as shown in FIG. 5.

The maximum travel of the carriage 7 on the movable part 9 is delimited by an end stop 22 on the movable part 9 in for the top position of the carriage 7 and by an end stop 23 for the bottom position of the carriage 7.

The lift 1 is further provided with a drive for the carriage 7.

In the case of the drawings, the drive is formed by a cable 25 that is wound on a shaft 26 that is fastened on the frame 3 above the fixed part 8, and which is provided with a motor or hoisting device (not shown) for rolling up and unrolling the cable 25.

The cable 25 is fastened at one end to the shaft 26, and at the other end to the carriage 7.

The use of the lift 1 is very simple and is illustrated on the basis of FIGS. 3 to 5.

FIG. 3 shows the situation in which the bicycle rack 2 is in the highest position whereby the cable is rolled up to a maximum.

In this situation the end stop 22 of the movable part 9 rests on the carriage and the cable 25 bears the combined weight of the movable part 8 and the carriage 7 with the bicycle rack 2 and any bicycles present on it.

When, on the basis of the situation in FIG. 3, the cable is unwound, the carriage 7 with the bicycle rack 2 together with the movable part 8 descends along the fixed part 8 of the guide 6 until the movable part 9 has reached its lowest position where the end stops 17 and 18 come into contact with one another at a maximum length B of the guide, as shown in FIG. 4.

When the cable 25 is further unwound, the movable part 9 stays in its lowest position and the carriage 7 descends further along the movable part 9 until the carriage 7 comes into contact with the end stop 23 and/or until the bicycle rack 2 reaches the ground, as shown in FIG. 5.

At this moment bicycles can be placed on the bicycle rack 2 with little difficulty and the bicycle rack with the bicycles loaded on it can be pulled upwards again by winding up the cable 25 again.

In that case the carriage 7 is first moved upwards along the movable part 9 until it is against the end stop 22, as in FIG. 4, and is then pulled further upwards together with the movable part 9 up to a situation as shown in FIG. 3, in which the bicycles are stored at a relatively safe height, in order to go on the road.

In order to compensate somewhat for the weight of the bicycle rack and the bicycles, thereby alleviating the lifting of the bicycle rack, a spring or gas spring (not shown) can be affixed between the fixed part 8 and the carriage 7.

Optionally the bicycle rack 2 can be provided with a frame 27 by which it is fastened below the level of the carriage in such a way that the bicycle rack 2 is height adjustable with respect to the carriage 7.

This is illustrated on the basis of FIG. 6 in which the bicycle rack 2 is in its highest position with respect to the carriage 7, in comparison to FIG. 3 in which the bicycle rack 2 is in its lowest position with respect to the carriage 7.

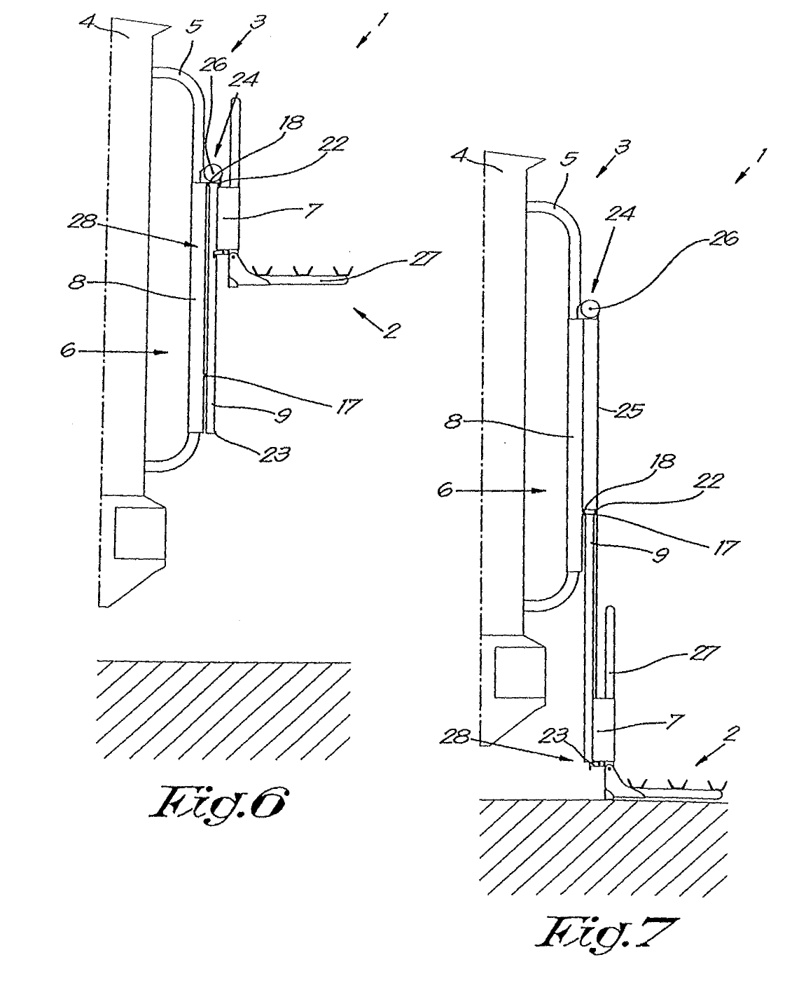

This enables the height of the bicycle rack 2 to be adjusted, as a function of the height at which the frame 3 is mounted on the motor home 4, in order to place the bicycle rack just above or on the ground at the maximum unwinding of the cable 25, as shown in FIG. 7, so that the cable 25 never slackens, which could otherwise lead to the cable 25 entangling while being wound up.

FIG. 6 also illustrates that the brackets 5 of the frame 3 are extendable with respect to the situation of FIG. 3, so that the top fastening point of the frame 3, for example, can be chosen to be higher according to the position of a window or similar for example.

Optionally cable break protection 28 can also be provided, which as shown in FIG. 8 is formed for example by a cam that is fastened rotatably on the carriage 7 and to which the cable 25 is secured. The cam 29 is drawn against the carriage 7 in the anticlockwise direction by the tension in the cable 25 and is held in the position of FIG. 8 against the action of a spring (not shown in the drawings), which tends to rotate the cam in the clockwise direction.

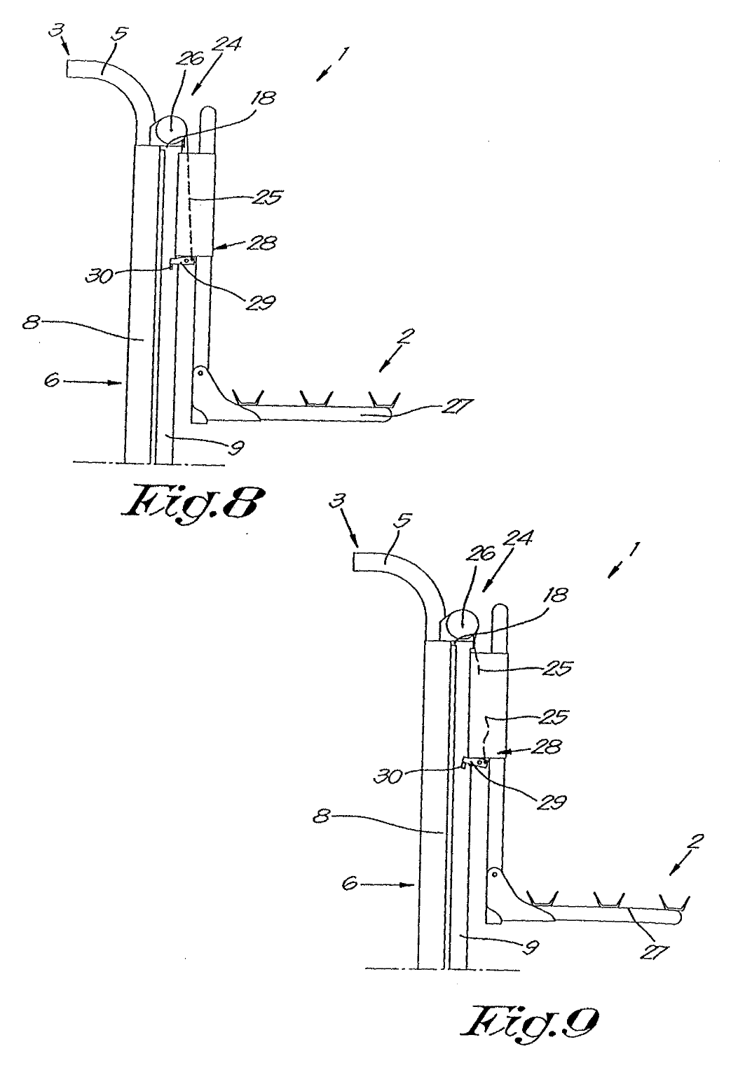

When the cable breaks, as shown in FIG. 9, the spring rotates the cam 29 to the position of FIG. 9, whereby the cam 29 catches in a hole 30 of a hole pattern that is provided to this end in the fixed part 8 and/or movable part 9. As a result, the falling of the carriage 7 is prevented.

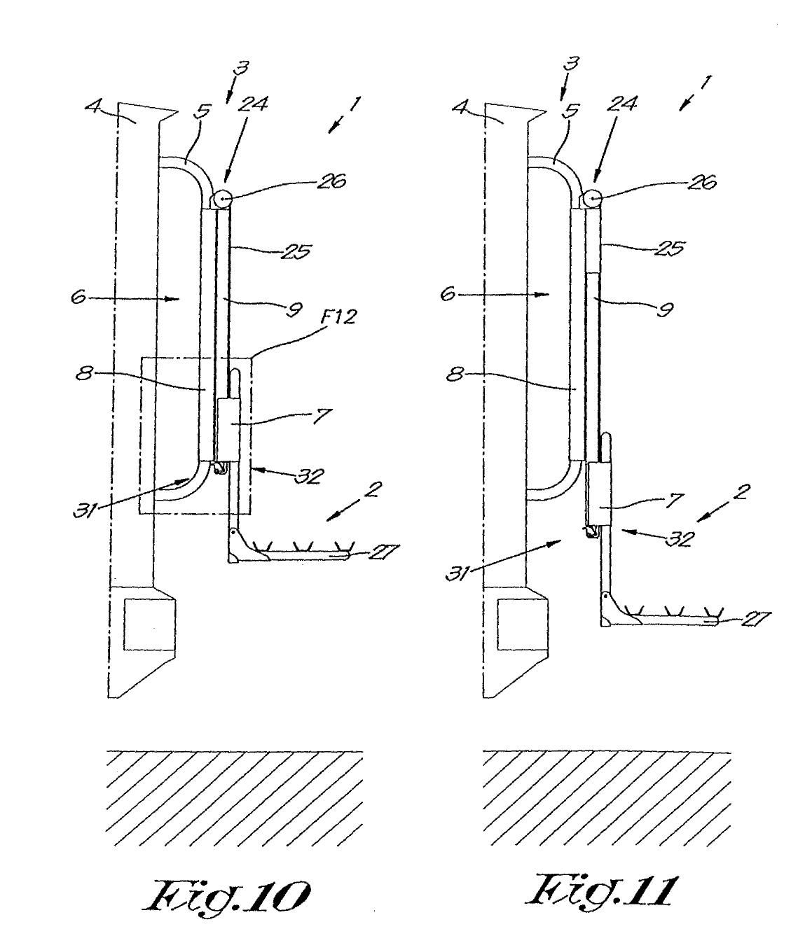

FIGS. 10 and 11 show a variant of a lift 1 according to the invention, whereby in this case, when unwinding the cable 25 from a position as shown in FIG. 3, the downward movement of the movable part 9 of the guide 6 with respect to the fixed part is first blocked by means of a first latch 31 until the carriage 7 has reached its bottom position on the movable part 9, as shown in FIG. 10, whereby the first latch 31 is then released and the movable part 9 can freely descend with respect to the fixed part 8.

A second latch 32 ensures that, in this situation with the carriage 7 in its bottom position, the downward movement of the movable part 9 with respect to the carriage 7 is blocked so that the movable part 9 does not suddenly shoot downwards when the first latch 31 is released and rests on the carriage 7 so to speak, which at that point in time is held by the cable 25.

When the cable 25 is further unwound, the carriage 7 together with the movable part 9 resting on it will thus descend until when the bicycle rack 2 is on the ground, as shown in FIG. 11.

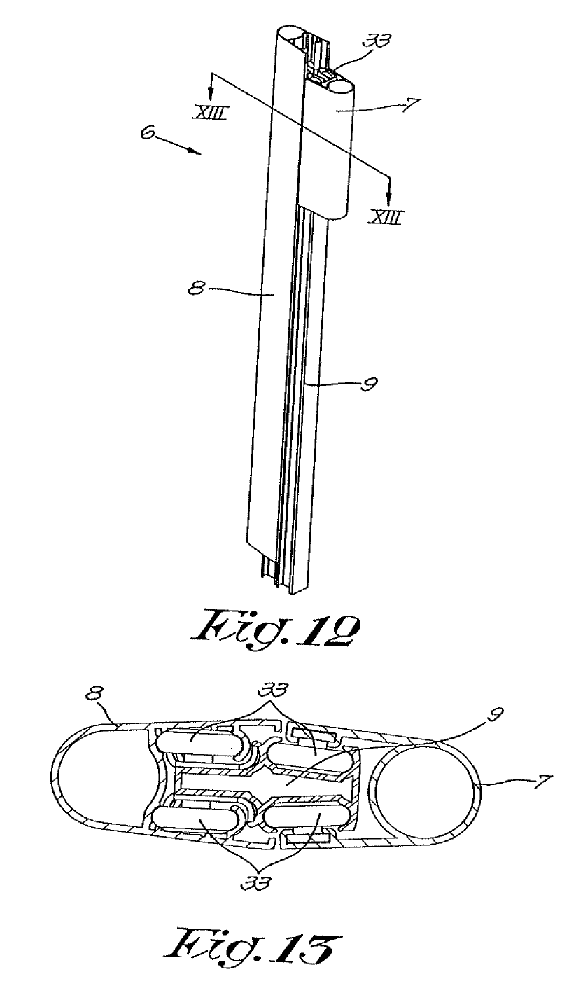

The guide 6 can be made extendable in many ways. An alternative embodiment of such a guide 6 with a fixed part 8 and a movable part 9 with a carriage 7 thereon is shown in FIGS. 12 and 13, whereby in this case the guide is mutually supported between the parts by small wheels 33.

It is clear that the use of a lift 1 with a rack 2 according to the invention is not limited to vehicles, but can also be mounted against a wall of a garage or similar, for example, in order to store bicycles or other articles out of the way at a height, whereby the loading and unloading can be easily done by the rack 2 being lowered to the ground or at a short distance above it.

It is clear that a separate frame 3 for mounting the lift 1 is not necessary and that the frame 3 can also be integrated in or formed by the fixed part 8 of the guide 6.

The present invention is by no means limited to the embodiments described as an example and shown in the drawings, but a lift for a bicycle rack or luggage rack according to the invention can be realised in all kinds of forms and dimensions, without departing from the scope of the invention.

1. Lift for a bicycle rack or luggage rack, whereby this lift (1) comprises a frame (3) for mounting against a wall; a guide (6) provided on this frame (3) which in the mounted situation of the lift (1) extends in an essentially upward direction; a height-adjustable carriage (7) on this guide (6) to which the bicycle rack or luggage rack (2) is fastened; and drive means (24), motorised or manual, for moving the carriage (7), characterised in that the guide (6) is extendable by comprising a ‘fixed part’ (8) that is fastened on the frame (3) and a ‘movable part’ (9) that can be moved vertically with respect to the fixed part (8) of the guide, between a position of minimum length (A) and a position of maximum length (B), whereby the aforementioned carriage (7) is affixed in a height adjustable way on the movable part (9) of the guide (6) between a top and a bottom position on this movable part (9).

2. Lift according to claim 1, characterised in that the fixed part (8) and the movable part (9) of the guide (6) are movable with respect to one another, such that the length of the guide is extendable with respect to its minimum length (A) by at least 50%, preferably by at least 60%, and most preferably by at least 70%.

3. Lift according to claim 1, characterised in that the bicycle rack or luggage rack (2) is fastened to the carriage (7) via a frame (27) at a height below the level of the carriage (7).

4. Lift according to claim 3, characterised in that the frame (27) of the bicycle rack or luggage rack (2) is height adjustable with respect to the carriage (7).

5. Lift according to claim 1, characterised in that the movable part (9) of the guide (6) is approximately just as long or longer than the fixed part (8).

6. Lift according to claim 1, characterised in that the fixed part (8) and the movable part (9) of the guide (6) are constructed as profiles that are movable parallel to one another in their longitudinal direction.

7. Lift according to claim 1, characterised in that the carriage (7) is movable over the entire or practically entire length of the movable part (9) of the guide (6).

8. Lift according to claim 1, characterised in that the movable part (9) of the guide (6) is provided with an end stop (22) or latch (32) by which the movable part (9) can rest on the carriage (7).

9. Lift according to claim 1, characterised in that the movable part (9) of the guide (6) is provided with an end stop (23) on which the carriage can rest in the bottom position of the carriage (7).

10. Lift according to claim 1, characterised in that it is provided with a spring or gas spring between the fixed part (8) of the guide (6) and the carriage (7).

11. Lift according to claim 1, characterised in that there are two parallel guides (6), each with a carriage (7) on which the bicycle rack or luggage rack (2) is fastened.

12. Lift according to claim 1, characterised in that it is a lift (1) that is equipped to be fastened onto a motor home (4), caravan or similar.

13. Lift according to claim 1, characterised in that the drive (24) is formed by a cable (28) that is wound on a shaft (26) above the level of the fixed part (8) of the guide (6), whereby this cable (25) is fastened to the carriage (7), whereby the shaft (26) is rotatable in order to wind up or unwind the cable (25) to lower or raise the bicycle rack or luggage rack (2) to a transport or storage position.

14. Lift according to claim 13, characterised in that it is provided with cable-break protection (28) that automatically blocks the downward movement of the carriage (7) if the aforementioned cable (25) breaks.

15. Lift according to claim 1, characterised in that the frame (3) for mounting the lift (1) against a wall is adjustable in length.
